(19) United States
(12) Patent Application Publication
(10) Pub. No.: US 2014/0370970 A1
(43) Pub. Date: Dec. 18, 2014

(54) REPORTING AND WAGERING PROCESSING IN SERVER-CENTRIC WAGERING GAME SYSTEMS

(71) Applicant: WMS Gaming, Inc., Waukegan, IL (US)

(72) Inventors: Srinivyasa M. Adiraju, Vernon Hills, IL (US); Peter R. Anderson, Glenview, IL (US); Edward Q. Earley, Chicago, IL (US); Mark B. Gagner, West Chicago, IL (US); Jesse L. Garvey, Chicago, IL (US); Nickey C. Shin, Chicago, IL (US); John L. Walsh, Gurnee, IL (US)

(21) Appl. No.: 14/303,390

(22) Filed: Jun. 12, 2014

Related U.S. Application Data
(60) Provisional application No. 61/834,161, filed on Jun. 12, 2013.

(51) Int. Cl. G07F 17/32

(52) U.S. Cl. CPC G07F 17/3234
USPC 463/25

(57) ABSTRACT

Some embodiments include a method for operating a wagering game machine. The method can include detecting, via input devices of the wagering game machine, player inputs indicating wagers placed on wagering games; notifying, via one or more networks, a wagering game server about the wager. The method can include receiving, from the wagering game server via the one or more networks, results for the wagering games. The method can include presenting the results of the wagering games on at least one display device of the wagering game machine, and receiving, from the game server via the network, information indicating the wagers placed on the wagering games and wagers paid for the wagering games. The method can also include reporting, by the wagering game machine via the one or more networks, the information to a slot accounting system.

### RELATED APPLICATIONS

This application claims the priority benefit of U.S. Provisional Application Ser. No. 61/834,161 filed Jun. 12, 2013.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### FIELD

Embodiments of the inventive subject matter relate generally to wagering game systems, and more particularly to server-based architectures that support standard reporting protocols.

### BACKGROUND

Wagering game system architectures have been evolving to offer a wider variety of features and functionalities. In the beginning, wagering game machines were purely mechanical devices. Over time, machines began utilizing electronics, such as computerized currency validators, electronic input devices, electronic display devices, etc. Soon after incorporating electronic devices, wagering game systems began utilizing communication technologies, such as Ethernet, Wi-Fi, and the like. Reliable communication technologies have enabled wagering systems to distribute functionality across numerous remote devices. For example, some gaming systems utilize a centralized game server to determine game results, while those game results are presented on wagering game machines in a casino. Other systems utilize networks to distribute new game content, enabling operators to quickly reconfigure wagering game machines. Yet other wagering game systems communicate with specialized non-gaming systems, such as casino slot accounting systems, player financial account systems, social websites, etc.

### BRIEF DESCRIPTION OF THE FIGURES

Embodiments of the invention are illustrated in the Figures of the accompanying drawings in which:

FIG. 1 shows components and operations for reporting accounting information to an external accounting system, according to some embodiments of the inventive subject matter.

FIG. 2 shows a wagering game system capable of operating in cashless and cash-based modes

FIG. 3 is a block diagram illustrating a system based gaming architecture, according to some embodiments of the inventive subject matter.

FIG. 4 is a block diagram illustrating a system supported gaming architecture, according to some embodiments of the inventive subject matter.

FIG. 5 is a block diagram illustrating a game client according to some embodiments of the inventive subject matter.

FIG. 6 is a flow diagram illustrating operations for a wagering game server supporting wagering game machines operating in cash-based and cashless modes.

FIG. 7 is a block diagram illustrating a wagering game network 600, according to example embodiments of the invention.

### DESCRIPTION OF THE EMBODIMENTS

Some embodiments include an on-demand multigame platform with which wagering game machines can offer large game libraries. The wagering game machines may include operating system functionality that enables devices, such as ticket acceptors, ticket printers, etc. In some embodiments, the wagering game machines interact with wagering game servers to access the large game libraries. The game servers determine may determine game results, and the machines may present the results using web browsers. These embodiments may enable game libraries originally designed for online casinos to operate on wagering game machines in brick-and-mortar casinos.

### Reporting Information to External Systems

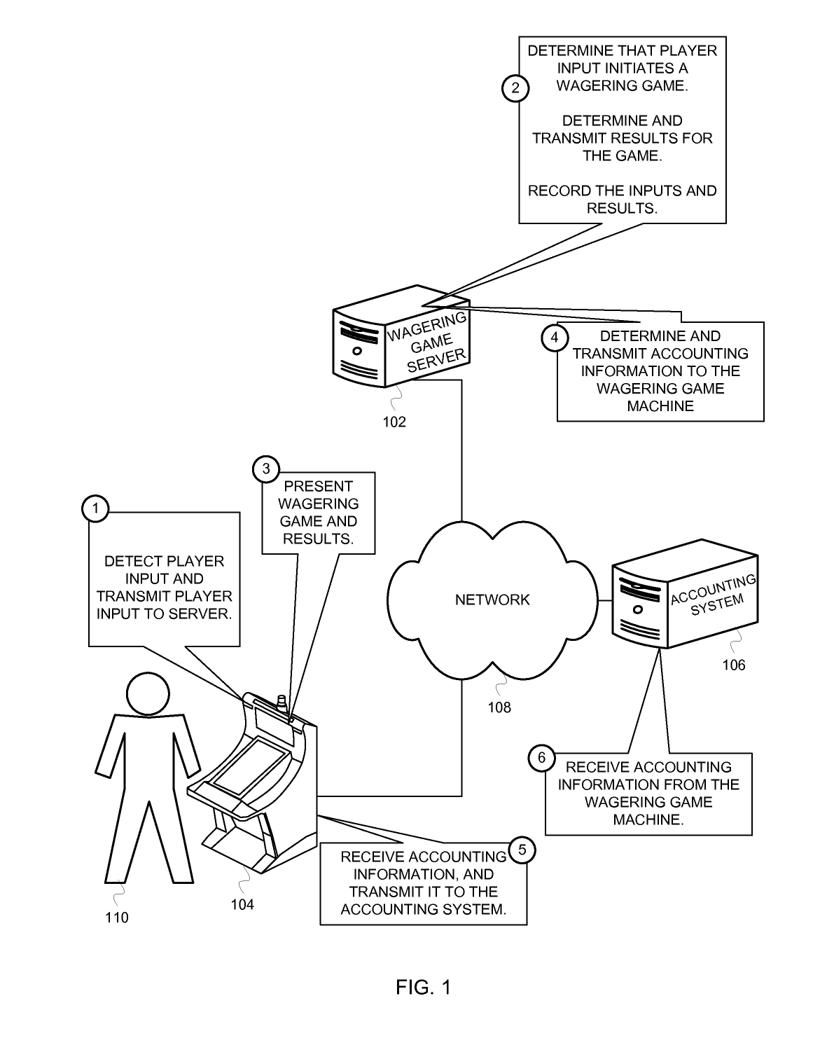

Some embodiments of the inventive subject matter enable wagering game machines to operate with centralized wagering game servers, and communicate with remote accounting systems. With the growth of centralized wagering game servers, wagering game machines are becoming minimal, thin-client machines. That is, many machines do not include components beyond those necessary for presenting wagering game results. Without certain components, thin-client wagering game machines cannot communicate with slot accounting systems, and other external systems. Because wagering game machines may be thin clients, wagering game servers (not machines themselves) may store information needed by slot accounting systems, and other systems. Some existing slot accounting protocols (e.g., SAS commercially available from IGT of Reno, Nev.) are designed to facilitate communications between wagering game machines and non-gaming systems. Some embodiments enable systems that store accounting information on a centralized wagering game server to communicate accounting information to slot accounting systems. As a result, despite evolving wagering game technologies, embodiments enable wagering game systems to utilize standard protocols to provide information to external systems, such as slot accounting systems. FIG. 1 shows this in more detail.

FIG. 1 shows components and operations for reporting accounting information to an external accounting system, according to some embodiments of the inventive subject matter. FIG. 1 shows a wagering game system including a wagering game machine 104 and a wagering game server 102, both of which are connected to a network 108. FIG. 1 also shows an accounting system 106 connected to the network 100. The wagering game server 102 can determine results for wagering games presented on the wagering game machine 104. For example, if a player 110 plays a slots game on the machine 104, the machine 104 procures a result from the wagering game server 102, and presents the results using content (e.g., graphics, animations, audio, music, etc.) stored on the machine 104. As noted above, the wagering game machine 104 may operate as a thin client. As a result, the machine 104 may not include components for storing account information, such as wagers made, wagers paid, value received in the machine 104, value paid out of the machine 104, etc. Nevertheless, embodiments enable the wagering game machine 104 to transmit accounting information to the accounting system 106. The operations shown in FIG. 1 show how some embodiments achieve this.

During stage 1, the wagering game machine 104 detects player input and transmits the player input to the wagering game server 102. In some instances, the machine 104 operates as a thin client, and therefore does not itself interpret the player input. Instead, the machine 104 forwards the input to the server 102.

During stage 2, the server 102 determines that the player input initiates a wagering game on the machine 104. The server 102 also determines a result for the wagering game, and transmits the result to the machine 104. Additionally, the server 102 records the inputs and result.

During stage 3, the wagering game machine 104 receives the result from the server 102, and presents the result in a wagering game. In some embodiments, the wagering game machine 104 includes content with which to present the wagering game and the results. For example, the machine 104 itself includes audio content (e.g., music, sound, etc.), video content (e.g., animation, graphics, etc.), and program code for presenting a wagering game including the result. The machine 104 can present the audio and video content on display and sound devices in its cabinet or otherwise connected to the machine 104. In some instances, the machine 104 and server 102 conduct an ongoing dialogue in which the machine provides a plurality of player inputs and the server responds with intermediate and final game results. Furthermore, stages 1-3 may repeat any number of times before stage 4 occurs.

During stage 4, the wagering game server 102 determines accounting information and transmits the accounting information to the wagering game machine 104. In some instances, the server 102 determines account information at the end of a business day or other time period. In some embodiments, the server determines the account information based on the player inputs and results. For example, for a particular time period, the server can examine the player inputs and results to determine total wagers made on the machine 104, each wager made on the machine 104, total value collected by the machine 104, total value paid by the machine 104, etc. As noted, the server 102 transmits this information to the machine 104.

During stage 5, the wagering game machine 104 receives the accounting information from the wagering game server 102. After receiving the accounting information, the machine 104 transmits the accounting information to the accounting system 106. In some embodiments, the wagering game machine 104 transmits the accounting information according to the Slot Accounting System (SAS) protocol developed by IGT of Reno, Nev., the Game To System (G2S) protocol developed by the Gaming Standards Association (GSA) of Fremont, Calif., or any other protocol suitable for communicating information between a wagering game machine and other systems, such as slot accounting systems, etc.

During stage 6, the accounting system 106 receives the accounting information from the wagering game machine.

Stages 1-6 explain how some embodiments enable server-oriented wagering game systems to utilize standardized protocols for communicating accounting information to separate systems. For example, because the SAS protocol is designed to facilitate communications between wagering game machines and accounting systems, some embodiments port accounting data to wagering game machines for reporting to external accounting systems.

Although not shown in FIG. 1, the wagering game server 102 can derive any suitable information based on player inputs, results, etc., and transmit that information to wagering game machines for dissemination to other external systems via standardized protocols.

### Synchronizing Cash-Based and Cashless Gaming

Some embodiments of the inventive subject matter enable wagering game machines to operate in cashless and cash-based modes. In such systems, wagering game machines may reside on a casino floor, and the wagering game server may reside in a secure area of the casino. The wagering game machines can present game content (e.g., graphics, audio, etc.) to players, while the server determines game results. For some cash-based operation, wagering game servers expect wagering game machines to collect wagers via bill/ticket/coin acceptors. Therefore, the wagering game servers may not be concerned with details about funding wagers. However, for cashless operation, wagering game servers may be responsible for procuring wagering funds. Wagering game servers may procure wager funding by debiting funds from player accounts managed by remote player account servers. Some embodiments enable wagering game systems to work in both cash-based and cashless modes.

Flexibility to operate in both cash-based and cashless modes is relevant to various deployment scenarios. In some deployment scenarios, wagering game systems may offer both new and classic wagering games. For new games, systems may offer features that require player accounts, where players login to the player accounts before playing games. Using the player accounts, systems can store: game states, progress through episodic games, badges, achievements, etc. As for classic games, many were created before the advent of account-based gaming. To preserve the classic game experience, some systems or some games hosted on a system may not offer account-based features, such as player account login, cashless gaming, etc. As a result, some embodiments enable players to play classic games on modern equipment, while having experiences much like when the classic games were originally available.

In other deployment scenarios, operators may want to give players an option of account-based play or anonymous play (i.e., play that does not require players to log into player accounts). When operating in an account-based mode, wagering game machines can procure funds from remote systems, save game information (e.g., progress through episodic games, achievements, etc.) to remote systems, and otherwise interact with external systems. When operating in anonymous mode, wagering game machines must procure funds without interacting with player account systems. That is, in anonymous mode, wagering game machines receive funds via local devices (e.g., ticket validators). In some instances of anonymous mode, wagering game machines do not persist game information after a game session ends (i.e., machines do not save episodic progress, etc.).

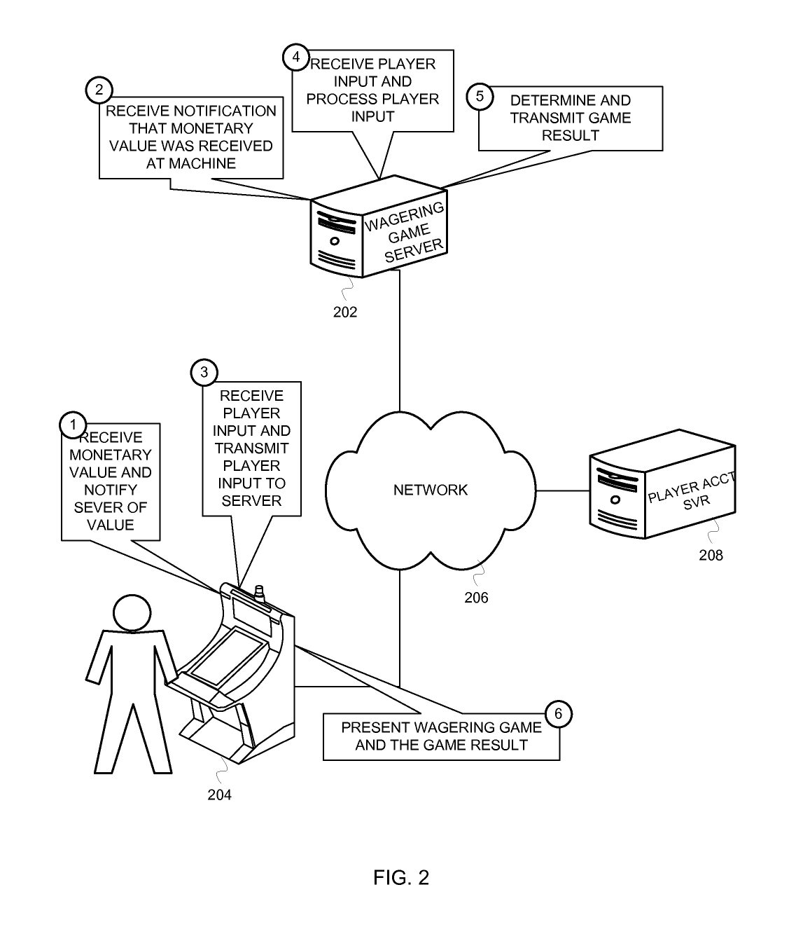

FIG. 2 shows a wagering game system capable of operating in cashless and cash-based modes. In FIG. 2, a wagering game system includes a wagering game server 202 and wagering game machine 204, both connected to a network 206. A player account server 208 is also connected to the network 206. When operating in cashless mode, the machine 204 receives player account login information, and forwards it to the server 202. Using the login information, the server 202 can access funds stored in a player's financial account on the player account server 208. Therefore, in cashless mode, the wagering game machine 204 need not receive monetary value via a ticket/currency validator located on or about the machine 204.

The operations of FIG. 2 describe a cash-based mode of operation. The operations shown in FIG. 2 occur in six stages. During stage 1, the wagering game machine 204 receives monetary value (e.g., currency, ticket, token, etc.) via a value input device. In some embodiments, the value input device can include a bill validator, ticket validator, coin validator, etc. After receiving monetary value, the machine 204 notifies the server 202 about the value received. Additionally, the machine 204 creates wagering credit for placing wagers.

During stage 2, the wagering game server 202 receives the notification indicating that monetary value was received at the machine 204. After receiving such a notification, the wagering game server 202 need not procure funds from a player account managed by the player account server.

During stage 3, the wagering game machine receives player inputs, and transmits those player inputs to the server for processing. During stage 4, the server 202 receives the player inputs and processes them. Processing player inputs can include determining that inputs initiate wagering games, place wagers, move game pieces, etc. Based on the player inputs, the server 202 determines game flow, tracks wagers, and determines game results. During stage 5, the server 202 transmits game results and any necessary game flow information (e.g., information indicating game-related decisions made by the server 202) to the machine 204.

During stage 6, the wagering game machine 204 presents content (e.g., audio, graphics, animations, etc.) indicating game results determined by the server 202.

As noted above, because the wagering game machine 204 and wagering game server 202 can work together in both cashless and cash-based modes, they can support various deployment scenarios (see above). Additionally, they can accommodate players who want to provide monetary value directly to the wagering game machine 204, and players who want to utilize funds stored in player accounts.

Some jurisdictions allow players to fund wagers via credit card. Some embodiments may treat wager funding via credit card as cashless gaming, while other embodiments may treat it as cash-based gaming. In some embodiments, the wagering game machines may be equipped with credit card readers and logic for communicating with external credit card systems. These embodiments may treat credit-card-based wagering like other cashless transactions. On the other hand, wagering game machines that do not include logic for communicating with external credit card systems treat credit-card-based wagering as cash-based transactions.

In some embodiments, the operations described above can be performed by components not described herein. In certain embodiments, the operations can be performed by executing instructions residing on machine-readable storage media, while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown above.

Architectures of Some Embodiments

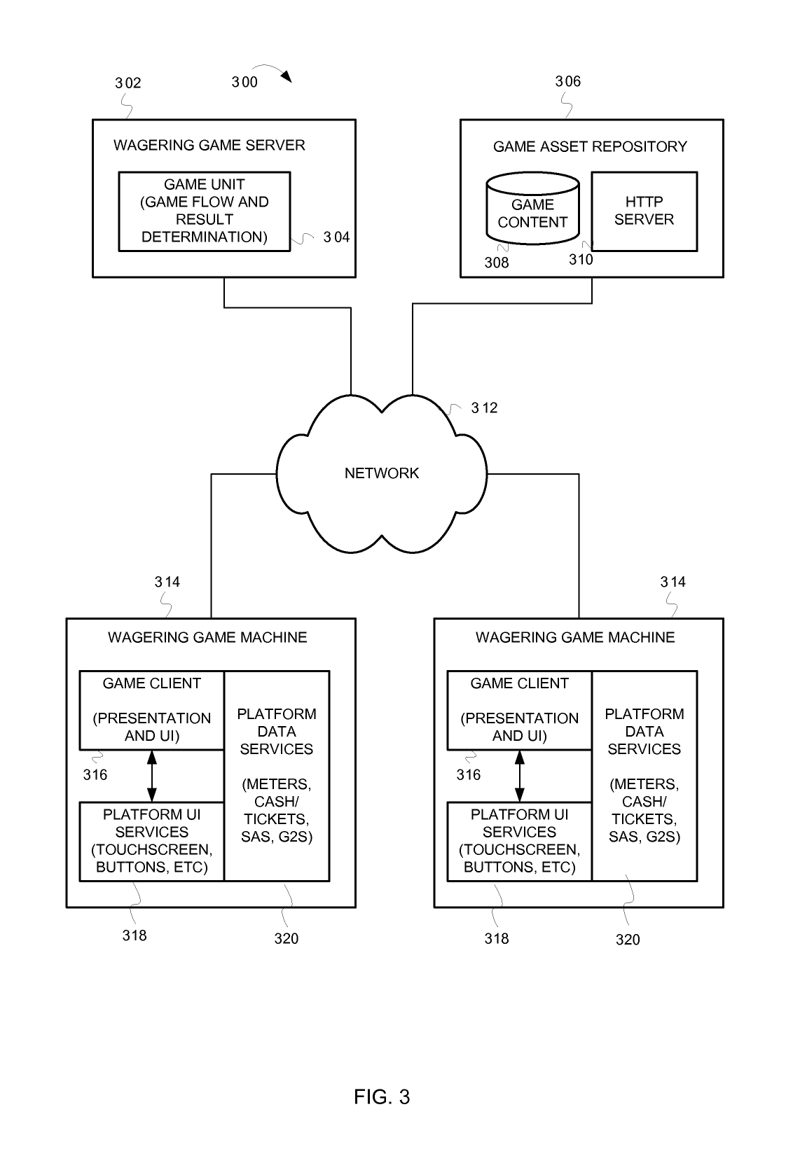

This section describes example system and component architectures of some embodiments of the inventive subject matter. FIGS. 3-5 are described below.

FIG. 3 is a block diagram illustrating a system based gaming architecture, according to some embodiments of the inventive subject matter. As shown in FIG. 3, a gaming system 300 includes a wagering game server 302, game asset repository 304, and wagering game machine 314. These components are connected to a network 312. The wagering game machine 314 can take any suitable form, such as a cabinet-based casino-style machine, a mobile computing device (e.g., tablet computing device, mobile phone, etc.), etc. The network 312 can support any suitable communication protocols, such as WiFi, 3G, 4G, Ethernet, etc.

In some embodiments, the gaming system 300 is capable of conducting “System Based Games”, in compliance with Nevada gaming regulations. Accordingly, some may consider the “gaming device” as including both the server 302 and a wagering game machine 314. When conducting system based games, the wagering game machines 314 cannot operate independently from the wagering game server 302. Thus, both components are needed to conduct wagering games (e.g., a server determines a game result and a machine presents the result).

As shown, the wagering game server 302 includes a game unit 304, which determines game flow and results for wagering games. The game unit 304 transmits game flow information and results to the wagering game machines 314 via the network 312.

The game asset repository 306 can deliver content (e.g., audio, graphics, animations, etc.) to the machines 314 via the HTTP server 310 and the network 312. The machines 314 can use the content to present wagering games including results determined by the server 302. In some embodiments, the game asset repository 306 transmits game content to the wagering game machine's platform data services 324 for presentation by the game client 316.

Each of the machines 314 includes a game client 316, platform user interface services 318, and platform data services 320. The game client 316 can receive game flow information and results from the server's game unit 304. Additionally, the game client 316 can present a user interface through which players can interact with the machine 314, play games, and see game results. In some embodiments, the user interface is presented on a web browser. The platform user interface services 318 facilitate player interaction with the game client's user interface. For example, the platform user interface services 318 includes code for processing player input from devices, such as touchscreens, buttons, etc. The platform data services 320 include code for tracking value inputs (e.g., cash, coins, tickets, etc.), credit meters, and reporting to external systems (e.g., casino accounting systems) using standardized protocols, as described herein.

In some embodiments, the architecture shown in FIG. 3 can perform the operations of FIGS. 1 and 2. That is, the wagering game machines 314 can operate in both cashless and cash-based modes. Furthermore, the wagering game server 302 can accumulate accounting information, and provide each wagering game machine 314 with accounting information specific to that machine. In turn, the wagering game machines 314 can use standard protocols (e.g., SAS, G2S, etc.) to report their respective accounting information to external accounting systems.

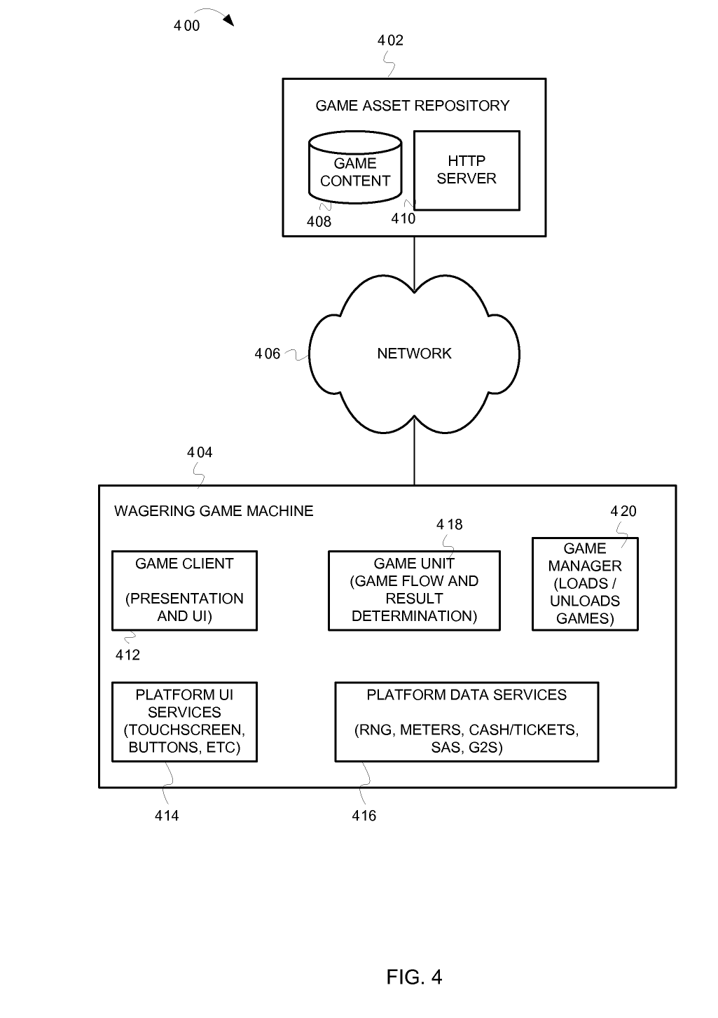

FIG. 4 is a block diagram illustrating a system supported gaming architecture, according to some embodiments of the inventive subject matter. In FIG. 4, the gaming system 400 includes a game asset repository 402, and a wagering game machine 404. The game asset repository 402 and wagering game machine 404 can communicate with each other over a network 406. Although only one wagering game machine appears in FIG. 4, the system 400 can include any suitable number of wagering game machines.

In some embodiments, the gaming system 400 is capable of conducting “System Supported Games”, in compliance with Nevada gaming regulations. When conducting system supported games, the wagering game machine 404 can operate independently of other devices in the system 400. That is, in some embodiments, the wagering game machine 404 can independently collect funds, determine game results, and present wagering games.

The game asset repository 402 can deliver content (e.g., audio, graphics, animations, etc.) and other suitable game assets to the machines 404 via the HTTP server 410 and the network 406. The machine 404 can use the content to present wagering games. In some embodiments, the game asset repository 402 transmits game content to the wagering game machine's game manager 420.

The machine's game unit 418 can determine game flow and results for wagering games. The game unit 418 transmits game flow information and results to the game client 412. The game client 412 can receive game flow information and results from the game unit 418. Additionally, the game client 412 can present a user interface through which players can interact with the machine 404, play games, and see game results. In some embodiments, the user interface is presented on a web browser. The platform user interface services 414 facilitate player interaction with the game client's user interface. For example, the platform user interface services 414 include code for processing player input to devices, such as touchscreens, buttons, etc. The platform data services 416 include code for tracking value inputs (e.g., cash, coins, tickets, etc.), credit meters, and reporting to external systems (e.g., casino accounting systems).

In some embodiments, the architecture shown in FIG. 4 can perform the operations of FIGS. 1 and 2. That is, the wagering game machine 402 can operate in both cashless and cash-based modes. In cashless mode, the wagering game machine 402 can procure wagering funds from player accounts managed by remote systems, such as the player account server. In cash-based mode, the machine 402 can procure monetary values via a value input device (e.g., ticket validator). As a result, the architecture shown in FIG. 4 can support various deployment scenarios, such as those configured to provide classic cash-based gaming, and contemporary cashless gaming.

As described above, the architectures of FIGS. 3 and 4 include game asset repositories, and communication channels by which the repositories can disseminate game assets. Therefore, some embodiments can provide any number of different wagering games to wagering game machines in an on-demand fashion. For example, the wagering game machine can offer a large selection of different wagering games. Upon player selection, the game asset repositories can provide game assets necessary for presenting the selected wagering games.

This discussion will continue by providing additional details about some embodiments of a game client.

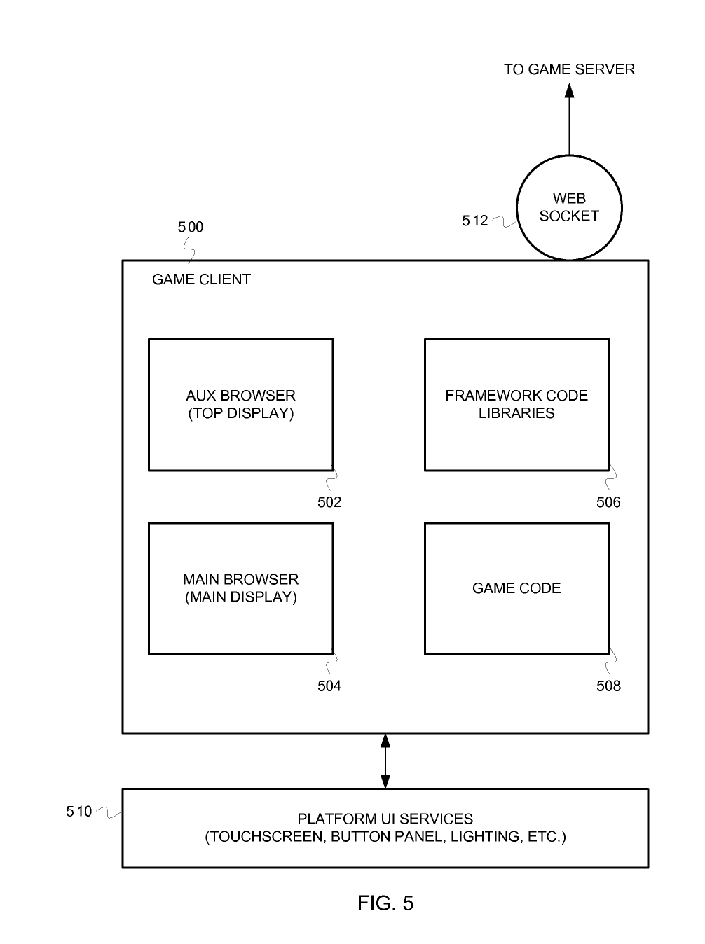

FIG. 5 is a block diagram illustrating a game client according to some embodiments of the inventive subject matter. As shown, a game client 500 includes an auxiliary browser 502, a main browser 504, framework code libraries 506, and game code 508. The main browser 504 can present content for wagering games on a wagering game machine's main display (e.g., a liquid crystal display). The auxiliary browser 502 can present content (e.g., bonus game content) on a secondary display, such as on an overhead display (a.k.a. top box). Because the game client 500 utilizes web browsers for presenting game content, the game content can be in any suitable web format, such as HTML 5, Adobe Flash, Microsoft Silverlight, etc.

In some embodiments, the game client 500 can receive game-related information (e.g., game results, game flow information, game code updates, etc.) via a web socket 512.

The framework code libraries 506 and game code 508 can include any suitable code for presenting wagering games. In some embodiments, the game code includes a graphics and game rendering engine, such as Unity commercially available from Unity Technologies of San Francisco, Calif.

The game client 500 can interact with the platform user interface services 510 as described above vis-à-vis FIGS. 3 and 4.

The next section provides additional details about wagering game networks, and how some embodiments operate in wagering game networks.

### Operations

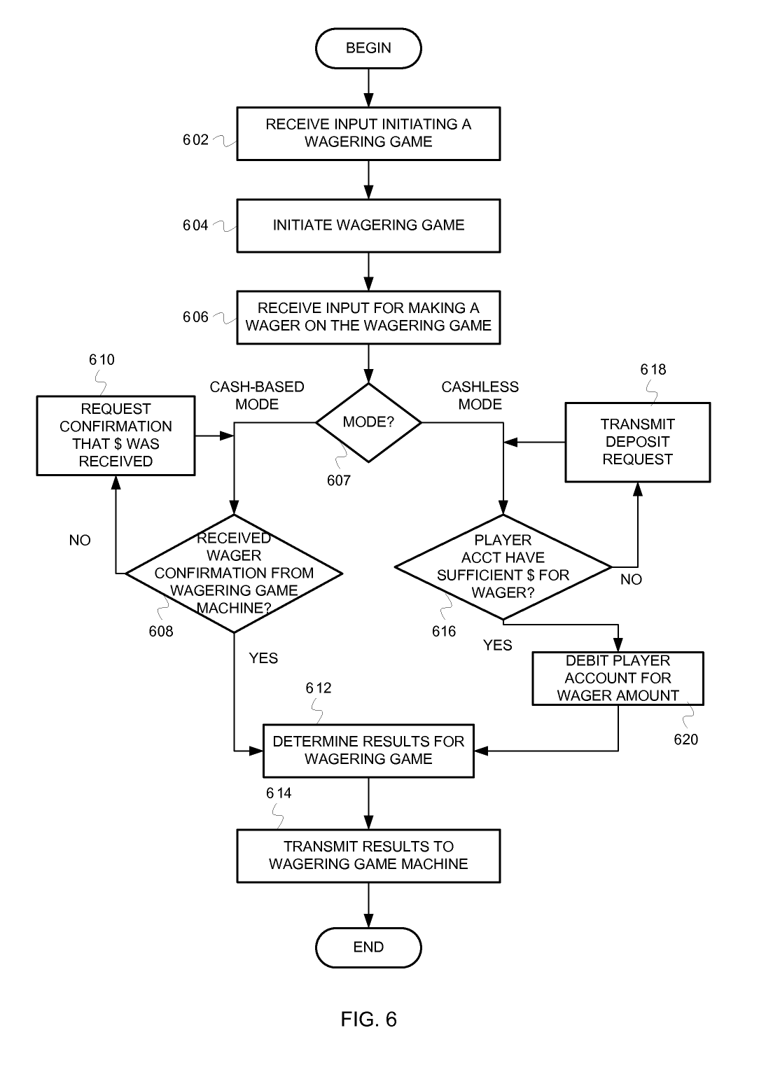

FIG. 6 is a flow diagram illustrating operations for a wagering game server supporting wagering game machines operating in cash-based and cashless modes. The flow 600 begins at block 602.

At block 602, the wagering game server receives, from a wagering game machine, input initiating a wagering game. For example, the wagering game machine can receive player inputs and forward those inputs to the wagering game server. The player inputs can indicate a player wants to initiating game. The flow continues at block 604.

At block 604, wagering game server initiates a wagering game. For example, the wagering game server's game flow unit initiates a wagering game. This operation may include transmitting game control information to the wagering game machine to facilitate presentation of content (e.g., audio, video, etc.) associated with wagering game. The flow continues at block 606.

At block 606, the wagering game server receives input indicating a player wants to make a wager on the wagering game. The flow continues at block 607.

At block 607, the wagering game server determines whether the wagering game machine is operating in cash-based mode or cashless mode. In some embodiments, the wagering game server can support the plurality of machines, some operating in cash-based mode and others operating in cashless mode. In some embodiments, the wagering game machines can operate in a particular mode based on the game being played. For example, for classic games, the wagering game machine may operate in cash-based mode. However, for contemporary games, the same wagering game machine may operate in cashless mode. If the wagering game machine is operating in cash-based mode, the flow continues at block 608. If the wagering game machine is operating in cashless mode, the flow continues at block 618.

At block 608 (cash-based mode), the wagering game server determines whether the wagering game machine has received monetary value for the wager. In some embodiments, the wagering game machine receives monetary value via a value input device, such as a ticket validator, bill validator, coin acceptor, etc. In some embodiments, the wagering game machine transmits an indication to the wagering game server, when the machine receives monetary value covering a wager.

If the server has not received confirmation that the machine has received monetary value covering wager, the flow continues at block 610. At block 610, wagering game server request confirmation that the machine has received monetary value covering wager. From block 610, the flow continues back to block 608.

If the server has received confirmation that the machine received monetary value covering wager, the flow continues at block 612, where the wagering game server determines results for the wagering game. For example, the wagering game server's game flow unit determines results for a slots game. The flow continues at block 614.

At block 614, the wagering game server transmits game results to the wagering game machine. After receiving results, the wagering game machine can present the results as part of the wagering game.

Referring back to block 607, if the wagering game machine is operating in cashless mode, the flow continues at block 616. At block 616, the wagering game server determines whether the player account has sufficient funds to cover the wager. In some embodiments, the wagering game server requests an account balance from a remote player account server. In other embodiments, the wagering game server itself maintains player accounts. If the player account does not have sufficient funds, the flow continues at block 618. At block 618, the wagering game server transmits a deposit request to the wagering game machine. When presented, the deposit request prompts the player to deposit funds sufficient to cover the wager in a player account.

Referring back to block 616, the player account has sufficient funds, the flow continues at block 620. At block 620, the wagering game server debits the player account for the wagering on. In some embodiments, wagering game server itself debit the player account. In other embodiments, wagering game server debits the account by communicating with a player account server. From block 620, the flow continues at block 612. The operations of blocks 612 and 614 have been discussed above. In

[symbol]

### Wagering Game Networks

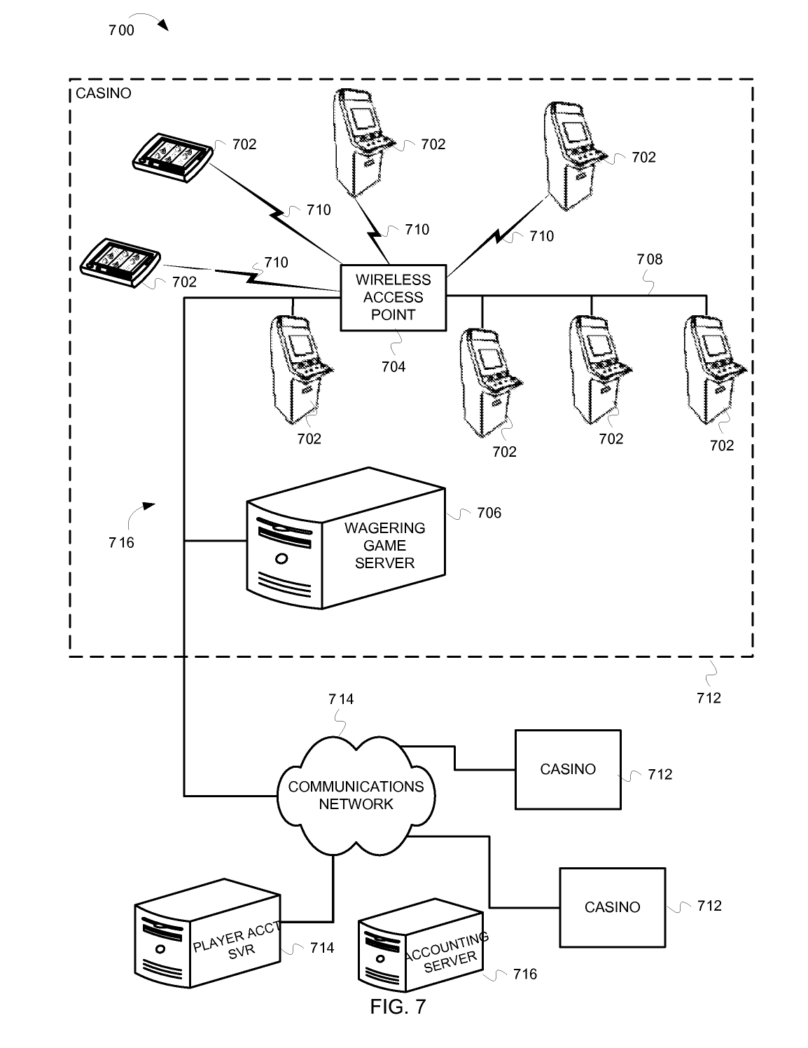

FIG. 7 is a block diagram illustrating a wagering game network 700, according to example embodiments of the invention. As shown in FIG. 7, the wagering game network 700 includes a plurality of casinos 712 connected to a communications network 714.

Each casino 712 includes a local area network 716, which includes an access point 704, a wagering game server 706, and wagering game machines 702. The access point 704 provides wireless communication links 710 and wired communication links 708. The wired and wireless communication links can employ any suitable connection technology, such as Bluetooth, 802.11, Ethernet, public switched telephone networks, 3G, 4G, SONET, etc. In some embodiments, the wagering game server 706 can serve wagering games and distribute content to devices located in other casinos 712 or at other locations on the communications network 714.

The wagering game machines 702 described herein can take any suitable form, such as floor standing models, handheld mobile units, bartop models, workstation-type console models, etc. Further, the wagering game machines 702 can be primarily dedicated for use in conducting wagering games, or can include non-dedicated devices, such as mobile phones, personal digital assistants, personal computers, etc.

The wagering game network 700 also includes an accounting server 716, and player account server 714. The network 700 can also include wide area progressive servers, player tracking servers, and/or other devices suitable for use in connection with embodiments of the invention.

In some embodiments, wagering game machines 702 and wagering game servers 706 work together such that a wagering game machine 702 can be operated as a thin, thick, or intermediate client (e.g., as described in FIGS. 1 and 2). For example, one or more elements of game play may be controlled by the wagering game machine 702 (client) or the wagering game server 706 (server). Game play elements can include executable game code, lookup tables, configuration files, game outcome, audio or visual representations of the game, game assets or the like. In a thin-client example, the wagering game server 706 can perform functions such as determining game outcome or managing assets, while the wagering game machine 702 can present a graphical representation of such outcome or asset modification to the user (e.g., player). In a thick-client example, the wagering game machines 702 can determine game outcomes and communicate the outcomes to the wagering game server 706 for recording or managing a player's account. In such thick-client examples, the game server 706 can transmit accounting information back to the machines 702 for reporting to the accounting server 716 via a standard protocol, such as SAS, G2S, etc.

In some embodiments, either the wagering game machines 702 (client) or the wagering game server 706 can provide functionality that is not directly related to game play. For example, account transactions and account rules may be managed centrally (e.g., by the wagering game server 706) or locally (e.g., by the wagering game machine 702). Other functionality not directly related to game play may include power management, presentation of advertising, software or firmware updates, system quality or security checks, etc.

Any component of the architecture 1100 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

Any component of the architectures described herein can include hardware, firmware, and/or machine-readable media including instructions for performing the operations described herein. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method for operating a wagering game machine, the method comprising:
detecting, via input devices of the wagering game machine, player inputs indicating wagers placed on wagering games;
notifying, via one or more networks, a wagering game server about the wager;
receiving, from the wagering game server via the one or more networks, results for the wagering games;
presenting the results of the wagering games on at least one display device of the wagering game machine;
receiving, from the game server via the network, information indicating the wagers placed on the wagering games and wagers won for the wagering games;
reporting, by the wagering game machine via the one or more networks, the information to a slot accounting system.

2. The method of claim 1, wherein the information also indicates denominations of the wagers placed on the wagering games, and denominations of the wagers won for the wagering games.

3. The method of claim 1 wherein the slot accounting system and the game server reside on different computing devices.

4. The method of claim 1, wherein the notifying includes transmitting information indicating the wagers collected and paid-out for the wagering games according to a Slot Accounting System (SAS) protocol.

5. The method of claim 1, wherein wagers on the wagering games are made using monetary value deposited into a receptacle of the wagering game machine.

6. A method for operating a wagering game machine, the method comprising:
receiving monetary value via a value input device of the wagering game machine;
creating, on the wagering game machine, wagering credit equivalent to the monetary value;
detecting a wager of at least a portion of the wagering credit on a wagering game;
transmitting, to the remote wagering game server over a network, a message indicating that the wagering game credit is sufficient to cover the wager;
after transmitting the message, receiving a result for the wagering game over the network from the remote wagering game server; and
presenting, on a display device of the wagering game machine, the result for the wagering game.

7. The method of claim 6 further comprising:
modifying, in the wagering game machine, the wagering game credit based on the result for the wagering game.

8. The method of claim 7 further comprising:
detecting a request to cash-out the wagering game credit; and
providing a ticket having value equal to the wagering game credit.

9. The method of claim 8 wherein after the detecting the request to cash-out the wagering game credit, the wagering game machine does not report the value of the wagering game credit for deposit in a player account.

10. The method of claim 6, wherein the wagering game machine does not report the monetary value for deposit in a player account.

11. The method of claim 6 further comprising:
creating, by the wagering game server, an anonymous account in association with the wagering game machine; and
crediting, by the wagering game server, the anonymous account in an amount equal to the monetary value.

12. A method for operating a wagering game server, the method comprising:
receiving, from a wagering game machine via a network, data indicating player input initiating a wagering game on the wagering game machine;
receiving, from the wagering game machine, a message indicating the wagering game machine has received monetary value sufficient to cover a wager on the wagering game;
determining, based on the message, that the wagering game machine has received monetary value sufficient to cover the wager on the wagering game;
determining, by the wagering game server, a result for the wagering game; and
after determining the wagering game machine has received monetary value sufficient to cover the wager on the wagering game, transmitting the result to the wagering game machine via a network.

13. The method of claim 12, wherein the determining that the wagering game machine has received monetary value sufficient to cover the wager on the wagering game occurs without accessing information about a player financial account.

14. The method of claim 12, wherein the determining that the wagering game machine has received monetary value sufficient to cover the wager on the wagering game is not based on information about a player financial account.

15. The method of claim 12, further comprising:
receiving, from a wagering game machine via a network, player input initiating a second wagering game on the wagering game machine;
receiving monetary value from a player account;
after receiving monetary value from the player account,
determining a second result for a second wagering game; transmitting the second result to the wagering game machine.
